(19) United States
(12) Patent Application Publication
(10) Pub. No.: US 2014/0116187 A1
(43) Pub. Date: May 1, 2014

(54) STEERING COLUMN ASSEMBLY WITH IMPROVED ATTACHMENT TO A VEHICLE STRUCTURE

(71) Applicant: Melvin L. Tinnin, Clio, MI (US)

(72) Inventor: Melvin L. Tinnin, Clio, MI (US)

(21) Appl. No.: 13/665,244

(22) Filed: Oct. 31, 2012

(51) Int. Cl. B62D 1/184

(52) U.S. Cl. 74/493

(57) ABSTRACT

A steering column assembly comprises an upper column jacket, a lock control shaft, a clamping block, a control wedge, and a wedge block. The clamping block is disposed about the upper column jacket and includes a first clamp arm and a second clamp arm. The first clamp arm defines a first cavity disposed along a cavity axis, and the second clamp arm defines a second cavity disposed along the cavity axis. The second clamp arm defines a clamp arm control opening that intersects with the second cavity. A control wedge has a control surface and is disposed in the clamp arm control opening. A wedge block is disposed in the first cavity and the second cavity and has a controlled surface positioned and configured to cooperate with the control surface to cause the clamping block to bear against the upper column jacket.

### BACKGROUND OF THE INVENTION

The present invention relates to steering columns and more particularly to systems and methods for releasably attaching a steering column assembly to a structure of a vehicle.

Market forces are inducing vehicle suppliers to seek ways of meeting the sometimes conflicting desires to incorporate new features into the areas surrounding the vehicle steering column while also providing more compact vehicles. As a result, demands for space surrounding the steering column have increased while the space available has decreased. In particular, it is becoming more and more common for the space above and below the column to be limited. These space-based constraints have posed challenges to designers seeking to meet simultaneous, and sometimes conflicting, requirements relating to structural attachment of the steering column to the vehicle, safety and reliability, and convenience. In particular, consumer desires for the ability to adjust positioning of the steering column have not decreased to accommodate the above-described increasing demands for space.

Accordingly, it is desirable to have improved systems and methods providing for safe and reliable structural attachment of the steering column to a vehicle structure while reducing use of space above and beneath the steering column. It is therefore desirable to have a system and method for selectively fixing and releasing a steering column wherein the clamping hardware is disposed primarily toward a side of the steering column (e.g., arranged substantially horizontally from the steering column).

### SUMMARY OF THE INVENTION

In one exemplary embodiment of the invention, a steering column assembly comprises an upper column jacket, a lock control shaft, a clamping block, a control wedge, and a wedge block. The clamping block is disposed about the upper column jacket and includes a first clamp arm and a second clamp arm. The first clamp arm defines a first cavity disposed along a cavity axis, and the second clamp arm defines a second cavity disposed along the cavity axis. The second clamp arm defines a clamp arm control opening that intersects with the second cavity. A control wedge has a control surface and is disposed in the clamp arm control opening. A wedge block is disposed in the first cavity and the second cavity and has a controlled surface positioned and configured to cooperate with the control surface to cause the clamping block to bear against the upper column jacket.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 shows a perspective view of an exemplary steering column assembly;

FIG. 2 shows a side view of an exemplary steering column assembly;

FIG. 3 shows a view of a portion of a steering column assembly, with segments of the steering column assembly cut away to show otherwise hidden aspects steering column assembly; and

FIG. 4 shows a perspective view of a portion of a steering column assembly.

### DETAILED DESCRIPTION

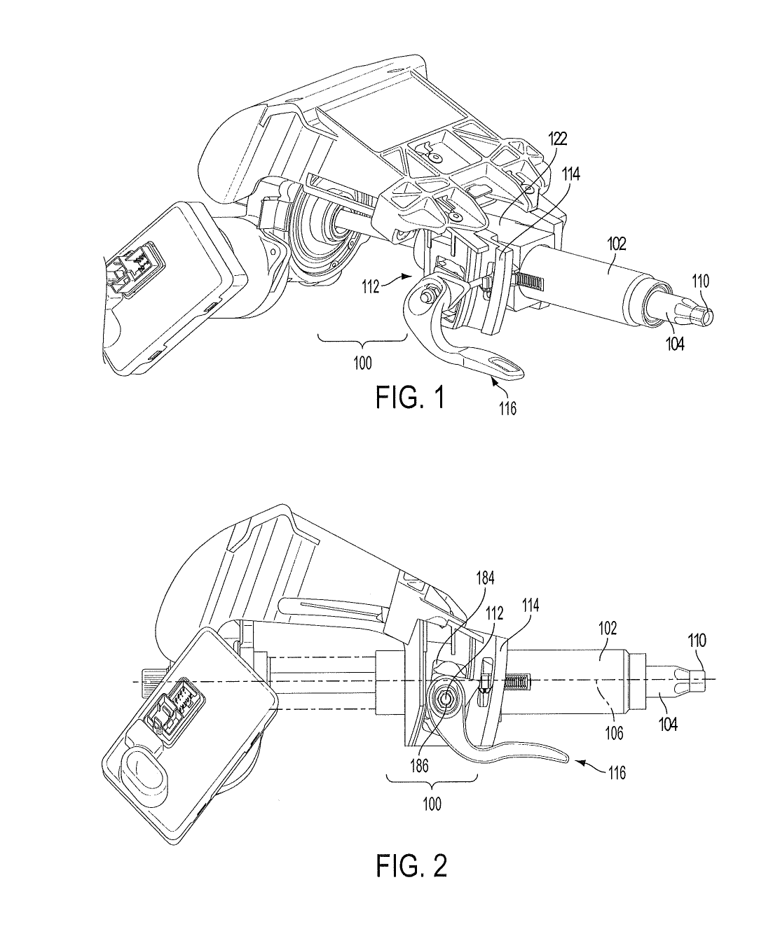

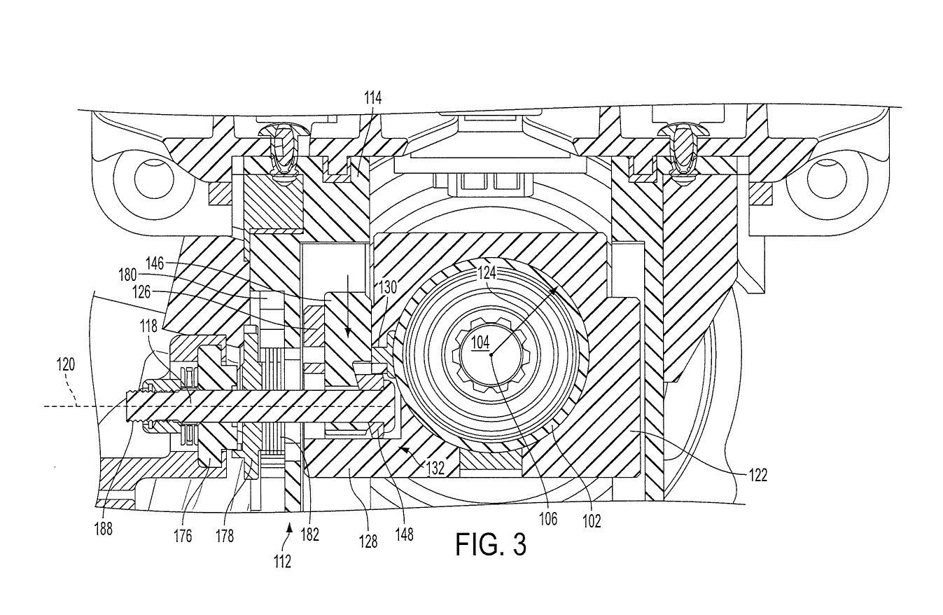

Referring now to the Figures, where the invention will be described with reference to specific embodiments, without limiting same, FIG. 1 and FIG. 2 show respective perspective and side views of a steering column assembly 100 in accordance with the invention. As shown in FIG. 1 and FIG. 2, the steering column assembly 100 comprises an upper column jacket 102, through which a steering control shaft 104 is supported for rotation about a longitudinal column axis 106. At an operator end (i.e., an upper end) 110, the steering control shaft 104 is configured for interacting with a steering wheel or other user control device (not shown) for facilitating user control of the vehicle. At an opposite end (i.e., a lower end) the steering control shaft 104 is coupled (e.g., via an intermediate shaft and/or one or more gear mechanisms) to a steerable wheel of the vehicle. Thus, as an operator rotates a steering wheel of the vehicle, the steering control shaft 104 rotates about the longitudinal column axis 106, and steering control of the vehicle is provided.

In an exemplary embodiment, the longitudinal column axis 106 is arranged in a vertically oriented plane that is parallel to a longitudinal axis of the vehicle. Adjustments to the position and orientation of the steering column assembly 100 may be facilitated in either or both of: (1) along a direction parallel to the longitudinal column axis 106 (i.e., in a telescoping direction); and (2) in a vertical (i.e., raking) direction substantially perpendicular to the longitudinal column axis 106. In an exemplary embodiment, the upper column jacket 102 defines an internal cavity, within which the steering control shaft 104 is supported. The upper column jacket 102 may be configured to facilitate telescoping movement of the steering control shaft 104 and its operator end 110 along the longitudinal column axis 106. To facilitate such adjustments to the position and orientation of the steering column assembly 100, as shown in FIG. 3, the steering column assembly 100 includes a position lock mechanism 112 that is attached to the upper column jacket 102.

To enable a locked mode, wherein changes to the position of an operator end 110 of the steering control shaft 104 are substantially inhibited, the position lock mechanism 112 is configured to substantially fix a position of the upper column jacket 102 relative to a column mounting bracket 114, and thus the vehicle, when the position lock mechanism 112 occupies the locked mode. Similarly, to enable an adjustment mode, wherein changes to a position of the operator end 110 of the steering control shaft 104 are facilitated, the position lock mechanism 112 is configured to permit adjustments to the position of the upper column jacket 102 relative to the column mounting bracket 114, and thus the vehicle, when the position lock mechanism 112 occupies the adjustment mode.

Those skilled in the art will appreciate that a number of systems and methods are known for enabling the above-described locked mode and adjustment mode. For example, a locked mode may be activated by imposing a compressive load between adjacent friction lock members or by engaging sets of mating gears so as to inhibit relative movement. Similarly, an adjustment mode may be activated by releasing the compressive loads or disengaging the gear teeth. To provide operator selectivity between a locked mode and an adjustment mode, an adjustment lever arm 116 may be provided for releasing or applying the compressive load (or for engaging and disengaging the gear teeth) based on the position of the adjustment lever arm 116.

In an exemplary embodiment, the position lock mechanism 112 includes a rake lock actuator (not shown) and/or a telescope lock actuator (not shown). The adjustment lever arm 116 is coupled to the rake lock actuator and/or the telescope lock actuator such that the vehicle operator may select (e.g., by manipulating the adjustment lever arm 116) whether the position lock mechanism 112 is to occupy the locked mode or the adjustment mode. In embodiments that provide for telescoping adjustments of the steering column assembly 100, the position lock mechanism 112 is configured to cooperate so as to selectively enable such telescoping adjustments while in the adjustment mode and to prevent such telescoping adjustments while in the locked mode. Similarly, in embodiments that provide for raking adjustments of the steering column assembly 100, the position lock mechanism 112 is configured to selectively enable such raking adjustments while in the adjustment mode and to prevent such raking adjustments while in the locked mode.

During normal operation of the vehicle, the position lock mechanism 112 occupies a locked mode such that the upper column jacket 102 is fixed relative to the column mounting bracket 114. To enhance vehicle safety in situations wherein the vehicle encounters an excessive acceleration (e.g., such that a vehicle occupant may impact or press against the steering column assembly 100), the position lock mechanism 112 may be configured to release from the vehicle upon imposition of an impact force of sufficient magnitude. Alternatively, it may be the position lock mechanism 112 that is configured to selectively release the upper column jacket 102. In either of these embodiments, however, the fixed relationship between the steering column assembly 100 and the vehicle is to be released upon the occurrence of the predetermined criteria. Thus, it is important for the attachment system and method to provide a reliable, yet releasable, structural attachment between the steering column and the vehicle. In an exemplary embodiment, the position lock mechanism 112 includes a lock control shaft 118 that is, when in a locked mode, fixed to (i.e., coupled for movement with) the upper column jacket 102, providing structural attachment between the steering column and the vehicle (e.g., between the upper column jacket 102 and the column mounting bracket 114). The lock control shaft 118 defines a control shaft axis 120 along its length.

FIG. 3 shows a cutaway view of an exemplary steering column assembly 100 viewed from the operator end 110 of the steering column assembly 100 and with the steering column assembly 100 being cut at a plane bisecting the position lock mechanism 112. As shown in FIG. 3, in an exemplary embodiment, the steering column assembly 100 comprises a clamping block 122 disposed circumferentially about the upper column jacket 102. The clamping block 122 defines a clamping block radius 124 and includes a first clamp arm 126 and a second clamp arm 128. Both clamp arms 126, 128 extend from respective ends 130, 132 of the clamping block 122. The ends 130, 132 are disposed proximate the outer surface of the upper column jacket 102, and the clamp arms 126, 128 extend in a radially outward direction therefrom. The first clamp arm 126 and the second clamp arm 128 are disposed adjacent to one another and define a gap 134 between the first clamp arm 126 and the second clamp arm 128 (i.e., between the ends 130, 132 of the clamping block 122). The first clamp arm 126 defines a gap-facing surface 136 (facing the gap 134) and an outer arm surface 138 that faces away from the gap 134.

The first clamp arm 126 defines a first cavity 140 that is disposed along a cavity axis 142 that is tangential to the outer surface of the upper column jacket 102. The second clamp arm 128 defines a second cavity 144 that is also disposed along the cavity axis 142 and that is aligned with, and contiguous with, the first cavity 140. A wedge block 146 is disposed in the first cavity 140 and the second cavity 144. The second clamp arm 128 defines a clamp arm control opening 150 that intersects with the second cavity 144. A control wedge 148 resides in the clamp arm control opening 150 and occupies at least part of the second cavity 144 where the second cavity 144 and the clamp arm control opening 150 intersect. The lock control shaft 118 passes through a control shaft passage 152 defined in the control wedge 148 and cooperates with the control wedge 148 and/or a wedge block 146 to fixedly position the lock control shaft 118 relative to the second clamp arm 128. In an exemplary embodiment, the clamp arm control opening 150 and the control wedge 148 are shaped in a complementary manner such that the control wedge 148 is prevented from rotating about the control shaft axis 120 relative to the second clamp arm 128.

Similarly, the control shaft passage 152 and an anti-rotation shoulder 154 of the lock control shaft 118 may be shaped in a complementary manner such that the lock control shaft 118 is prevented from rotating about the control shaft axis 120 relative to the control wedge 148. Accordingly, in an exemplary embodiment, the lock control shaft 118 and the control wedge 148 may be rotationally fixed (i.e., prevented from rotating) relative to the second clamp arm 128, and thus relative to the upper column jacket 102. In addition to rotationally fixing the lock control shaft 118, the control wedge 148 may be configured to fit within the clamp arm control opening 150, and the lock control shaft 118 may be configured to fit within the control wedge 148, such that the lock control shaft 118 is translationally fixed (i.e., prevented from translating) relative to the second clamp arm 128.

The wedge block 146 is configured for cooperating with the lock control shaft 118 and the control wedge 148 to draw the first clamp arm 126 toward the second clamp arm 128, thereby closing the gap 134 and reducing the clamping block radius 124 to cause the clamping block 122 to bear against the upper column jacket 102 and thus fix the clamping block 122 to the upper column jacket 102. Accordingly, the wedge block 146 includes a shoulder 156 at a shoulder end 158 of the wedge block 146. The shoulder 156 is configured to bear against the outer arm surface 138 as the wedge block 146 moves along the cavity axis 142 in a direction toward the control shaft axis 120. At an inserted end 160 of the wedge block 146, the inserted end 160 being distal from the shoulder end 158, the wedge block 146 defines a wedge block opening 162 through which the lock control shaft 118 may pass.

The wedge block 146 is configured to cooperate with the control wedge 148 and the lock control shaft 118 such that, as the lock control shaft 118 is placed in tension, a compressive load is applied to the wedge block 146 and the control wedge 148 by a shaft head 174 of the lock control shaft 118. The compressive load causes a control surface 164 of the control wedge 148 to bear against a controlled surface 166 of the wedge block 146, causing the wedge block 146 to move along the cavity axis 142 in a direction toward the second clamp arm 128 while the shoulder 156 bears against the outer arm surface 138 of the first clamp arm 126. The force exerted by the shoulder 156 on the outer arm surface 138 draws the first clamp arm 126 toward the second clamp arm 128, thereby closing the gap 134 and reducing the clamping block radius 124. As the clamping block radius 124 decreases, the clamping block 122 eventually bears against the upper column jacket 102 and thus fixes the clamping block 122 to the upper column jacket 102.

In an exemplary embodiment, the wedge block 146 defines a controlled surface 166 that faces in a direction that is angled toward the shoulder 156. At the same time, the control surface 164 of the control wedge 148 faces in a direction toward the controlled surface 166 (i.e., in a direction that is angled away from the shoulder 156). In an exemplary embodiment, the control surface 164 and the controlled surface 166 are configured as flat, planar surfaces.

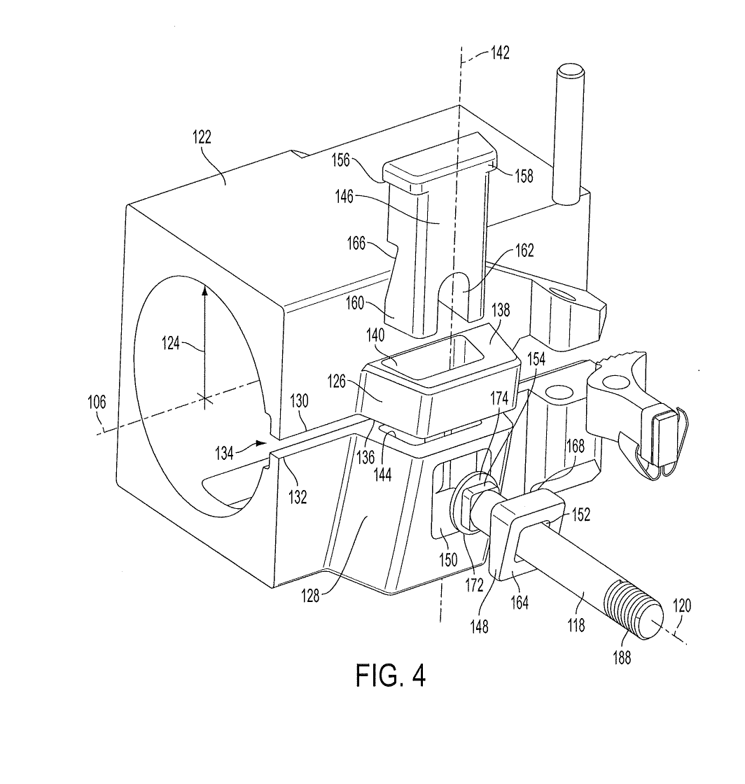

In an exemplary embodiment, as shown in FIG. 4, the wedge block 146 is disposed within the first cavity 140 and the second cavity 144 with its controlled surface 166 facing in a direction toward the upper column jacket 102. In accordance with this embodiment, the control wedge 148 is disposed between the wedge block 146 and the upper column jacket 102 with its control surface 164 facing away from the upper column jacket 102 toward the controlled surface 166. An in-board end 172 of a lock control shaft 118 defines a shaft head 174, which is disposed between the upper column jacket 102 and both the control wedge 148 and the wedge block 146. When the lock control shaft 118 is in tension, the shaft head 174 bears against the control wedge 148 and the wedge block 146 to impose a compressive load between the control wedge 148 and the wedge block 146.

The control wedge 148 defines a bearing surface 168 that faces toward the outer surface of the upper column jacket 102 such that the shaft head 174 of the lock control shaft 118 may bear against the bearing surface 168 when the lock control shaft 118 is placed in tension. When the lock control shaft 118 is placed in tension, the control wedge 148 and the wedge block 146 are placed in compression between the shaft head 174 of the lock control shaft 118 and the first clamp arm 126 and the second clamp arm 128 such that the control surface 164 bears against the controlled surface 166, biasing the wedge block 146 toward the lock control shaft 118 and the first clamp arm 126 toward the second clamp arm 128.

It should be appreciated that the wedge block 146 may also be disposed within the first cavity 140 and the second cavity 144 with its controlled surface 166 facing in a direction away from the upper column jacket 102. In accordance with this embodiment, the wedge block 146 would be disposed between the control wedge 148 and the upper column jacket 102 with its controlled surface 166 facing away from the upper column jacket 102 toward the control surface 164. When the lock control shaft 118 is placed in tension, the control wedge 148 and the wedge block 146 are placed in compression such that the control surface 164 bears against the controlled surface 166, biasing the wedge block 146 toward the lock control shaft 118.

A cam 176 and follower 178 are disposed about the lock control shaft 118 so as to facilitate imposition of a tension force on the lock control shaft 118. The cam 176 and follower 178 are configured for interacting with the lock control shaft 118 so as to draw the lock control shaft 118 along the control shaft axis 120 and to thereby place the lock control shaft 118 in tension. As the lock control shaft 118, and thus the shaft head 174, is drawn along the control shaft axis 120, the shaft head 174 imposes a compressive load between the control wedge 148 and the wedge block 146, thereby causing the first clamp arm 126 to move relative to the second clamp arm 128, closing the gap 134 and causing the clamping block radius 124 to decrease. Thus, movement of the lock control shaft 118 may cause the clamping block 122 to bear against the upper column jacket 102.

In an exemplary embodiment, the position lock mechanism 112 is disposed along a side of the upper column jacket 102 that is disposed along a substantially horizontal direction from the longitudinal column axis 106. The lock control shaft 118 defines a control shaft axis 120 along its length, and, in an exemplary embodiment, the control shaft axis 120 is disposed generally horizontally and passes through, or nearly through, the longitudinal column axis 106. In an exemplary embodiment, the lock control shaft 118 is arranged so that the control shaft axis 120 is directed substantially toward the longitudinal column axis 106. In an exemplary embodiment, the lock control shaft 118 is oriented substantially perpendicular to the upper column jacket 102.

As shown in FIG. 3, in an exemplary embodiment, the position lock mechanism 112 includes a position lock bracket 180 that is disposed about or adjacent to the upper column jacket 102 (which may be generally cylindrical in cross-sectional shape) and is configured for cooperating with mating lock plates 182. The position lock bracket 180, in cooperation with the lock plates 182, facilitates selectively enabling (i.e., in an adjustment mode) adjustments to the position of the upper column jacket 102, and thus the operator end 110 of the steering control shaft 104, within a range of adjustment provided by a lock bracket slot 184 (FIG. 2), which is defined in the position lock bracket 180.

In an exemplary embodiment, the lock control shaft 118 is disposed perpendicular to the position lock bracket 180 and the lock bracket slot 184, and is positioned within (i.e., as passing through) the lock bracket slot 184, such that, as a position of the upper column jacket 102 is adjusted, the lock control shaft 118, which is coupled for movement with the upper column jacket 102, traverses a range of motion within the lock bracket slot 184. To facilitate structural attachment to the vehicle (i.e., in a locked mode), the position lock bracket 180 is fixed to the column mounting bracket 114, which is fixed to the vehicle.

In an exemplary embodiment, the position lock mechanism 112 comprises one or more lock plates 182 disposed about the lock control shaft 118 adjacent to the position lock bracket 180 such that a compressive load imposed between the one or more lock plates 182 and the position lock bracket 180 causes friction between the one or more lock plates 182 and the position lock bracket 180, thereby resisting translation of the one or more lock plates 182, and thus the lock control shaft 118, relative to the position lock bracket 180.

In an exemplary embodiment, the lock bracket slot 184 and the lock plates 182 are configured such that lock plates 182 must rotate if the lock control shaft 118 translates and such that the lock control shaft 118 cannot translate if the lock plates 182 do not rotate. The lock plates 182 may be counter-rotating such that, translation of the lock control shaft 118 in a first direction causes adjacent lock plates 182 to rotate in opposite directions. When a compressive load is imposed between adjacent lock plates 182, the lock plates 182 are inhibited from rotating relative to one another.

In an exemplary embodiment, the lock control shaft 118 passes through the adjustment lever arm 116, the one or more lock plates 182, and the lock bracket slot 184 of the position lock bracket 180, as well as the cam 176, and a follower 178. A retainer 186 is disposed at an outboard end 188 of the lock control shaft 118 and may comprise a shaft head 174 fixed to the lock control shaft 118 or, alternatively, a threaded lock nut whose position on the lock control shaft 118 may be adjusted as it is threaded onto mating threads of the lock control shaft 118. At the in-board end 172 of the lock control shaft 118, the shaft head 174 cooperates with the lock control shaft 118 such that a compressive force (i.e., compressive load) may be exerted between the one or more lock plates 182 and the position lock bracket 180 as the lock control shaft 118 is placed in tension between the retainer 186 and the shaft head 174. As a result of the imposition of these forces, the one or more lock plates 182 may resist relative movement of the lock control shaft 118 relative to the position lock bracket 180. At the same time, the shaft head 174, in cooperation with the clamping block 122, the first clamp arm 126, the second clamp arm 128, the control wedge 148, and the wedge block 146, fixes the position of the lock control shaft 118 relative to the upper column jacket 102.

In an exemplary embodiment, the follower 178 is configured for interacting with the lock control shaft 118 and the cam 176 such that as the follower 178 rotates about the control shaft axis 120 (e.g., in response to actuation of the adjustment lever arm 116) in a locking direction, the follower 178 causes the lock control shaft 118 to be translated such that the shaft head 174 is drawn along the control shaft axis 120 and the lock control shaft 118 is placed in tension, (e.g., by bearing against the position lock bracket 180 and the cam 176) and activates a position lock system configured for resisting translation of the lock control shaft 118 in a direction substantially orthogonal to the lock control shaft 118. In an exemplary embodiment, the follower 178 may be configured for imposing a compressive load between two or more lock plates 182 and/or between one or more lock plates 182 and the position lock bracket 180.

Accordingly, the lock plates 182, in cooperation with the position lock bracket 180 and the upper column jacket 102, provides a mechanism for selectively enabling or preventing adjustments to the position of the operator end 110 of the steering control shaft 104 in at least the direction associated with interaction of the one or more lock plates 182 and the position lock bracket 180. It should be noted, however, that the one or more lock plates 182 and the position lock bracket 180 may be configured to provide adjustment of the position of the steering column assembly 100 along one axis or two axes. More specifically, the one or more lock plates 182 and the position lock bracket 180 may be configured to provide adjustment/locking along only the raking direction, along only the telescoping direction, or along both telescoping and raking directions.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A steering column assembly comprising:
an upper column jacket, through which a steering control shaft is supported for rotation about a longitudinal column axis;
a lock control shaft that defines a control shaft axis, the lock control shaft having an in-board end that defines a shaft head;
a clamping block disposed about the upper column jacket and including a first clamp arm and a second clamp arm, the first clamp arm and the second clamp arm extending in a radially outward direction from respective ends of the clamping block, the first clamp arm defining a first cavity disposed along a cavity axis that is substantially tangential to an outer surface of the upper column jacket, the second clamp arm defining a second cavity disposed along the cavity axis, the second clamp arm defining a clamp arm control opening that intersects with the second cavity, the clamping block defining a clamping block radius;
a control wedge disposed in the clamp arm control opening and at least partly in the second cavity, the control wedge having a control surface; and
a wedge block disposed in the first cavity and the second cavity, the wedge block having a controlled surface positioned and configured to cooperate with the control surface of the control wedge such that, as the lock control shaft is placed in tension, a compressive load is applied between the control surface and the controlled surface, whereby the wedge block is caused the move along the cavity axis in a direction toward the second clamp arm, causing the clamping block radius to decrease and the clamping block to bear against the upper column jacket.

2. A steering column assembly as described in claim 1, wherein the clamp arm control opening and the control wedge are shaped in a complementary manner so as to prevent the control wedge from rotating about the control shaft axis relative to the second clamp arm.

3. A steering column assembly as described in claim 1, wherein:
the control wedge defines a control shaft passage through which the lock control shaft is disposed; and
the control shaft passage and an anti-rotation shoulder of the lock control shaft are shaped in a complementary manner so as to prevent the lock control shaft from rotating about the control shaft axis relative to the control wedge.

4. A steering column assembly as described in claim 1, wherein:
the wedge block defines a shoulder configured to bear against the first clamp arm as the wedge block moves along the cavity axis toward the control shaft axis;
the controlled surface is angled toward the shoulder; and
the control surface of the control wedge is directed toward the controlled surface.

5. A steering column assembly as described in claim 1, wherein the control surface and the controlled surface are configured as flat, planar surfaces.

6. A steering column assembly as described in claim 1, wherein the controlled surface is directed toward the upper column jacket, and the control surface is directed away from the upper column jacket in a direction toward the controlled surface.

7. A steering column assembly as described in claim 1, wherein an in-board end of the lock control shaft defines a shaft head, and wherein the shaft head is disposed between the upper column jacket and both the control wedge and the wedge block.

8. A steering column assembly as described in claim 1, wherein the control wedge defines a bearing surface that faces toward the outer surface of the upper column jacket such that the shaft head may bear against the bearing surface when the lock control shaft is placed in tension.

9. A steering column assembly as described in claim 1 wherein the wedge block is disposed within the first cavity and the second cavity between the control wedge and the upper column jacket and the controlled surface of the wedge block is directed away from the upper column jacket and toward the control surface.

10. A steering column assembly as described in claim 1, wherein the lock control shaft is disposed so that the control shaft axis is directed substantially toward the longitudinal column axis.

11. A steering column assembly as described in claim 1, wherein the lock control shaft is disposed so that the control shaft axis is directed substantially toward the upper column jacket and beneath the longitudinal column axis.

12. A steering column assembly as described in claim 1, wherein the lock control shaft is disposed so that the control shaft axis is directed substantially toward the upper column jacket and above the longitudinal column axis.

13. A steering column assembly as described in claim 1, wherein the lock control shaft is disposed so that the control shaft axis is substantially horizontal.

14. A steering column assembly as described in claim 1, wherein:
the lock control shaft and the control wedge are rotationally fixed relative to the second clamp arm and the upper column jacket; and
the control wedge is configured to fit within the clamp arm control opening, and the lock control shaft is configured to fit within the control wedge, such that the lock control shaft is translationally relative to the second clamp arm.

15. A steering column assembly as described in claim 1, wherein a cam and follower are disposed about the lock control shaft so as to facilitate imposition of a tension force on the lock control shaft and to thereby cause the clamping block to bear against the upper column jacket.

16. A steering column assembly as described in claim 15, further comprising a cam follower that is configured for interacting with the cam and the lock control shaft such that, as the cam follower rotates in a locking direction, an axial lobe that is disposed on the cam follower imposes a tension in the lock control shaft and thereby activates a position lock system configured for resisting translation of the lock control shaft in a direction substantially orthogonal to the lock control shaft.

17. A steering column assembly as described in claim 16, wherein the position lock system comprises one or more lock plates disposed about the lock control shaft adjacent to a position lock bracket, the one or more lock plates and the position lock bracket being configured such that a compressive load imposed between the one or more lock plates and the position lock bracket causes friction between the one or more lock plates and the position lock bracket to resist translation of the one or more lock plates, and thus the lock control shaft, relative to the position lock bracket.

18. A steering column assembly as described in claim 17, wherein the cam follower is configured for imposing a compressive load between the one or more lock plates and the position lock bracket.

19. A steering column assembly as described in claim 1, wherein a position lock bracket defines a lock bracket slot along a raking direction, through which the lock control shaft is disposed.

20. A steering column assembly as described in claim 1, wherein a position lock bracket defines a lock bracket slot along a telescoping direction, through which the lock control shaft is disposed.
